(19) United States
(12) Patent Application Publication
(10) Pub. No.: US 2006/0054540 A1
(43) Pub. Date: Mar. 16, 2006

(54) Automatically cleaned filter with cotton core

(76) Inventor: Bun Wong, Hong Kong (CN)

Correspondence Address: Greenberg Traurig, Suite 400E, 2450 Colorado Avenue, Santa Monica, CA, 90404, US

(21) Appl. No.: 10/509,778

(22) PCT Filed: Apr. 3, 2003
(86) PCT No.: PCT/CN03/00242

§ 371 Date: Jul. 11, 2005

(30) Foreign Application Priority Data
Apr. 4, 2002 (CN) 02102544.5

(51) Int. Cl. A01K 63/04; B01D 35/02

(52) U.S. Cl. 210/169; 210/416.2

(57) ABSTRACT

The present invention relates to an automatically cleaned filter with cotton core. Said filter comprises an outer case, a cotton core and a pump. Said case comprises a lid that can be opened to put into the cotton core, a water inlet and one or more water outlets. Said case further comprises an inside cleaning apparatus that can be operated like a washing machine to clean its cotton core inside and connected with a motor outside the case. Said filter can be used for cleaning the cotton core regularly and automatically so as to avoid need of hand-washing the cotton core, and has no necessary to frequently replace the cotton core, thus reducing using cost of the cotton core.

### TECHNICAL FIELD

The present invention relates to a filter, and more particularly, relates to an automatically cleaned filter with cotton core, which can be used in the fish jar or rearing pond to automatically clean its cotton core inside.

### TECHNICAL BACKGROUND

In general, it is frequently needed to replace water in the fish jar or rearing pond for keeping the water therein to be clean. To meet requirements of economizing water resource, however, it is necessary to recycle water in the fish jar or rearing pond, i.e., necessity of usual filtering and removing impurities in the fish jar or rearing pond. For this purpose, the present fish jar or rearing pond is provided with a filter to clean and filter water in the fish jar or rearing pond.

At present, however, for the filter used in the fish jar or rearing pond, it is necessary to clean the filter screen and cotton core inside, both of which are rather dirty after usage. Therefore, many people would rather to directly replace them than clean, which is inevitably to bring about high cost of the filter screen and cotton core, and further increase the cost of screening procedures and that of keeping fish. In addition, the cotton core used during the screening procedures may produce environmental pollution to certain extent if directly discarded, even though regardless of precondition of high costs.

### SUMMARY OF INVENTION

The object of this invention is to overcome insufficiencies of said filter, which is for solving such problems as necessity to manually wash extremely dirty filter screen and cotton core after use as well as increasing costs for keeping fish caused by non-cleaning the filter screen and cotton core.

For this purpose, the present invention provides an automatically cleaned filter with cotton core, comprising an outer case, a cotton core and a pump. Said case comprises a lid that can be opened to put the cotton core therein, a water inlet and one or more water outlets. Said case further comprises an inside cleaning apparatus that can be operated like a washing machine to clean its cotton core inside and connected with a motor outside the case.

In said filter, its cleaning apparatus is a cylinder installed inside the outer case in which the cotton core is provided, in the meantime, the side walls of the cylinder are provided with many filtering holes. Said cylinder is connected with a motor at rear side of the outer case. Said case comprises a water inlet and one water outlet with a pump connected. Said pump is connected with a splitter at its water outlet.

For said water filter, a secondary screening unit is installed at the outlet of the splitter unit, and active carbon is provided in the secondary screening.

In said filter, the cleaning apparatus is an agitator mounted in the outer case, which is connected with the motor at rear side of the outer case. Said outer case has one water inlet and two water outlets, and is connected with fish jar or rearing pond at one of its outlets via pump and piping, and connected with the outside sewage pipe at another outlet via piping. There is a switch valve on the pipe connected with the outside sewage pipe.

In said filter, its outer case is connected at its one outlet with a secondary filter in which the active carbon is provided. Said secondary filter is connected with said pump.

In said filter, its agitator is of fan-blade type.

In said filter, the cleaning apparatus is an agitator installed inside the outer case, which is connected with the motor at the front side of the outer case. The outer case has one water inlet and one outlet. One pump is installed at the inlet, one secondary screening unit or sewage pipe as well as one switch valve are provided at the outlet.

In said filter, the cleaning apparatus is an agitator installed inside the outer case, which is connected with the motor at the bottom of the outer case. The outer case has one water inlet and one outlet at its bottom, one water outlet is provided at its top, one pump is provided at its water inlet and one switch valve is provided at water outlet of its bottom, as well as one secondary filter is provided at the outlet of the top. Said secondary filter has active carbon inside.

In said filter, the cleaning apparatus is an agitator installed inside the outer case, which is connected with the motor at top side of the outer case. The outer case has one water inlet and one outlet at its top, one pump is provided at its water inlet, one splitter unit is provided at said water outlet, as well as one secondary filter with active carbon therein is provided at the bottom.

In said filter, there is a filter screen between active carbon and cotton core.

In said filter, a removable lid is provided on said cylinder or the cylinder is closed.

In said filter, the cotton core is made of one of the cotton, cloth, mesh, filter foam rubber, or filter screen or filter line that is used for the air conditioner.

In said filter, said cotton core can be made in bag shape, in which the active carbon or the cotton core into which the active carbon is added is provided.

When the filter of this invention is used for filtering and removing impurities contained in the water in fish jar or rearing pond, it is only necessary to start the pump so that the water in fish jar or rearing pond can flow into the cylinder and then the cotton core is used for filtering and removing impurities in the water, so that the filtered clean water can flow into the fish jar or rearing pond again. After a period of time, it is only necessary to start the motor to clean the cotton core inside the cylinder so that the sewage produced by cleaning cotton core can flow into the sewage piping.

This automatically cleaned filter with cotton core can be used for cleaning the cotton core regularly and automatically so as to avoid need of hand-washing the cotton core, and has no necessary to frequently replace the cotton core, thus reducing the cost of the cotton core and further decreasing costs for keeping fish.

The present invention also can be used for treatment of industrial and restaurant sewage.

### DESCRIPTION OF ATTACHED FIGURES

FIG. 1 is a usage condition diagram of an automatically cleaned filter with cotton core of this invention;

FIG. 2 is a structure view of the embodiment I of filter of this invention;

FIG. 3 is a structure view of the embodiment II of filter of this invention;

FIG. 4 is a structure view of the embodiment III of filter of this invention;

FIG. 5 is a structure view of the embodiment IV of filter of this invention;

FIG. 6 is a structure view of the embodiment V of filter of this invention.

### DESCRIPTION OF THE PREFERRED EMBODIMENTS

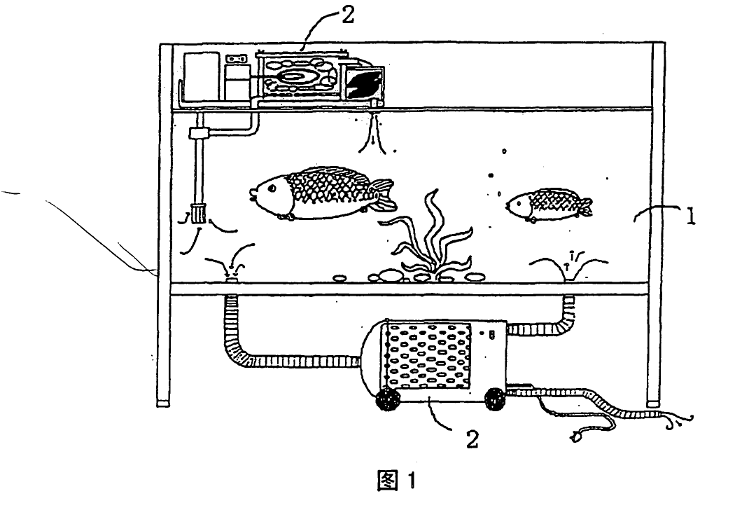

As shown in FIG. 1, the automatically cleaned filter 2 with cotton core of this invention can be arranged at bottom of the fish jar or rearing pond 1, or at top of the fish jar or rearing pond 1.

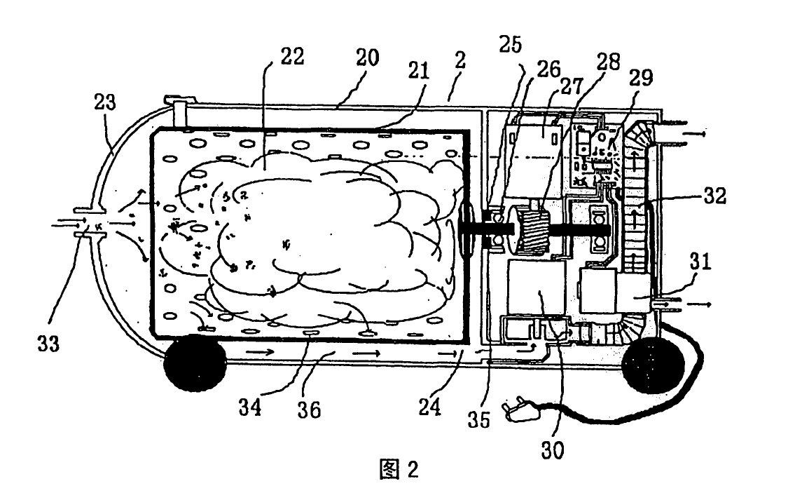

As shown in FIG. 2, the filter 2 comprises an outer case 20. Said case comprises at its one end an openable lid 23, on which there is a water inlet 33 that can be connected with the fish jar or rearing pond 1. The outer case 20 has a cylinder 21 inside, on the side wall of which there are many filtering holes 34. A cotton core 22 is provided inside the cylinder, which can filter and remove impurities in the water. A shaft rod 35 is fixed in the middle of the cylinder 21 and erected on the bearing 26 that is built on the wall of the outer case 20. There is a water-proof seal ring 25 set inside the bearing 26. The shaft rod 35 is connected with the motor 27 at the rear side of the outer case 20 as well as the reduction gear set 28 and driven by the motor 27 and the reduction gear set 28, so as to further drive the cylinder 21 to roll like a washing machine, thus cleaning the cotton core 22 inside the cylinder 21.

The cylinder 21 can be also provided with removable lid so as to take or put into the cotton core 22, or the cylinder 21 is closed with permanent cotton core 22 built in. The cotton core 22 can be made of one of the cotton, cloth, mesh, filter foam rubber, or filter screen or filter line that is used for the air conditioner. The cotton core 22 can be made in bag shape, in which the active carbon or the cotton core into which the active carbon is added is provided.

The cylinder 21 forms a water flow duct 36 between it and inside wall of the outer case 20. A water outlet 24 is arranged at bottom of the rear side of the outer case 20 and connected with the water inlet of the pump 30. The water outlet of the pump 30 is connected with the splitter 31 whose one outlet is communicated with the bottom of the fish jar or rearing pond 1 via a secondary filter 32 and piping and another outlet is connected with outside sewage pipe via piping.

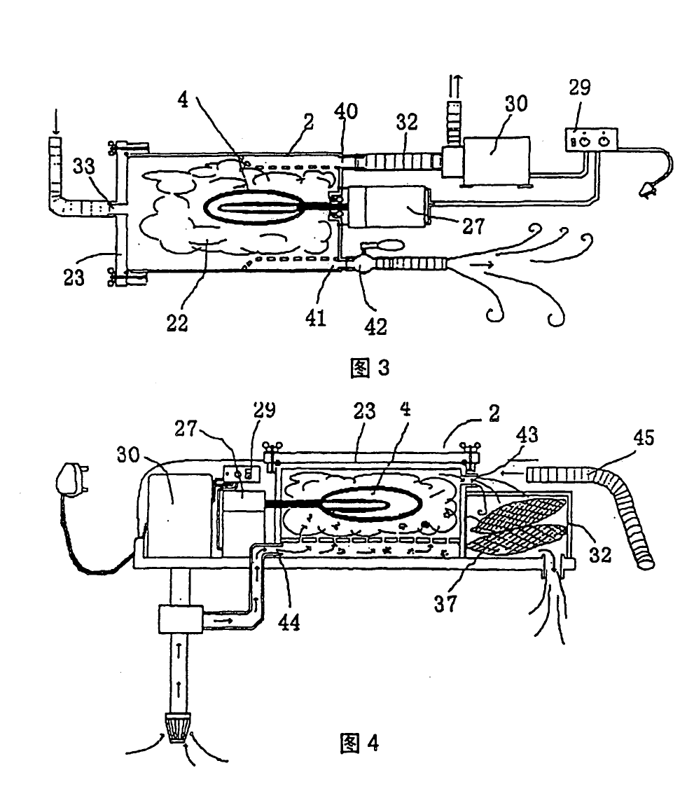

The secondary filter 32 has active carbon 37 therein, as shown in FIG. 4, which is used for further filtering and cleaning harmful substances in the water.

Said motor 27, pump 30 and splitter 31 are controlled by the control circuit board 29 at the rear side of the outer case 20. The circuit of the control circuit board 29 is selected from the present sound products in the market and the detailed description thereof is omitted here.

When the filter 2 of this invention is used, the whole filter 2 is first of all installed at the bottom of the fish jar or rearing pond 1. Its water inlets 33 and two outlets are respectively communicated with the rearing pond 1 and the outside sewage pipe. When the water inside the fish jar or rearing pond 1 is filtered or cleaned, it is only necessary to start the pump 30 and to communicate the splitter unit 31 with the bottom of the fish jar or rearing pond 1, in the meantime, the water in the fish jar or rearing pond 1 would flow into the cylinder 21 via the water inlet 33, and the cotton core 22 is used for filtering water. In such case, the cotton core 22 is not moved so that the impurities in the water are remained in the cotton core 22. The filtered clean water flows into the flow water duct 36 through the filter hole 34 on the side wall of the cylinder 21, and then returns back to the fish jar or rearing pond 1 by means of the pump 30 and the splitter 31.

A number of grimy substances that are accumulated in the cotton core 22 after long-term usage of the cotton core 22 in the filter 22 would deteriorate its filtering and cleaning functions, so it is necessary to regularly clean or replace the cotton core 22 inside the cylinder 21. In order to reduce the usage cost of the cotton core 22, it is only necessary to start the motor 27 to drive the cylinder 21 to rotate like a washing machine, thus cleaning the cotton core 22 inside the cylinder 21, at this time, the cotton core 22 is rolling to send the grimy impurities into the splitter unit 31. In such case, the distributary direction of the splitter 31 is changed to make the sewage produced by cleaning of the cylinder 21 to flow into the outside sewage pipe via the splitter 31.

As shown in FIG. 3, an agitator 4 can be arranged inside the outer case 20 of the filter 2 and is connected with the motor 27 at the rear side of the outer case 20, and is driven to stir by the motor 27 so as to clean the cotton core 22 in the outer case 20. Two water outlets 40 and 41 are arranged at the rear side of the outer case 20, in which one outlet 40 is connected with a secondary filter 32, another end of the secondary filter is connected with the bottom of the fish jar or rearing pond 1 through the pump 30. Another outlet 41 is communicated with the outside sewage pipe via the switch valve 42.

As shown in FIG. 4, the filter 2 in this invention can be installed at the top of the fish jar or rearing pond 1. For this purpose, an agitator 4 is arranged inside the outer case 20 of the filter 2 and is connected with the motor 27 at the front side of the outer case 20, and is driven to stir by the motor 27. A lid 23 that can be opened to put the cotton core 22 therein is set at the top of the outer case 20, a water inlet 44 is arranged at the bottom on one side of the case 20 and is communicated with the fish jar or rearing pond 1 through the pump 30. An outlet 43 is set at the top on another side of the outer case 20. The outlet 43 is communicated with the secondary filter 32 in case of filtering and is communicated with the outside sewage pipe via the pipe 45 in case of cleaning the cotton core 22.

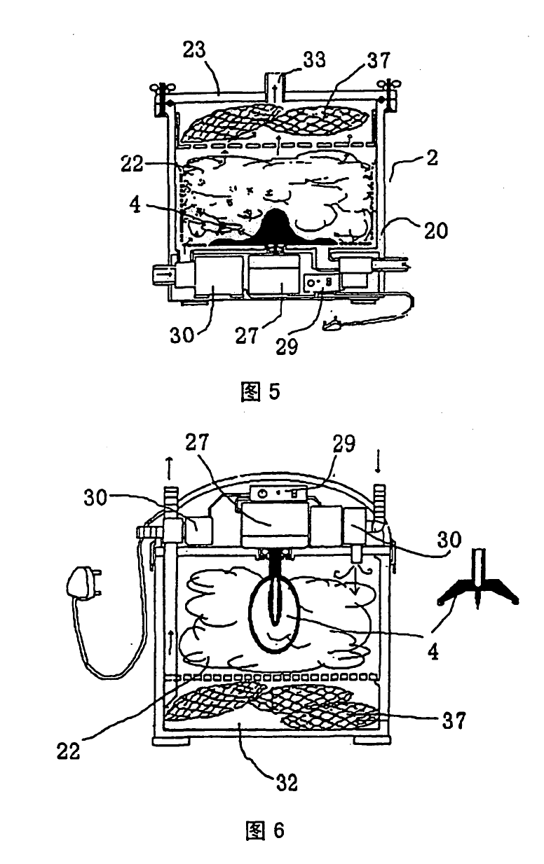

As shown in FIG. 5 and FIG. 6, the filter 2 of this invention can also be designed in the vertical structure, and the agitator 4 inside the outer case 20 of the filter can be either vertically or inversely arranged. The agitator 4 is in the fan blade shape so as to sufficiently stir the cotton core. In addition, such vertical structure can make whole filter looked more compact with small volume.

Concerning the above, the filter of this invention not only has no need to manually clean the cotton core, but also has no need to frequently replace cotton core, thus reducing using cost of the cotton core and further decreasing costs for keeping fish.

1. An automatically cleaned filter with cotton core, comprising: an outer case; a cotton core; and a pump, said outer case comprises a lid that can be opened to put the cotton core therein, wherein the outer case has a water inlet and one or more water outlets, said outer case further comprises an cleaning apparatus that can be operated like a washing machine to clean its cotton core inside and is connected with a motor outside the outer case.

2. The automatically cleaned filter with cotton core according to claim 1, wherein the said cleaning apparatus is a cylinder that is installed inside the outer case, the cylinder has cotton core therein and has many filtering holes on its side wall, the said cylinder is connected with a motor at the rear side of the outer case, the said outer case comprises a water inlet and one water outlet connected with a pump, said pump is connected with a splitter at its water outlet.

3. The automatically cleaned filter with cotton core according to claim 2, wherein a secondary screening unit is set at the outlet of the splitter, and active carbon is provided in the secondary screening.

4. The automatically cleaned filter with cotton core according to claim 1, wherein the cleaning apparatus is an agitator mounted in the outer case which is connected with the motor at the rear side of the outer case, said outer case has one water inlet and two water outlets, and is connected with fish jar or rearing pond at one of its outlets via pump and piping, and is connected with the outside sewage pipe at another outlet via piping, and there is a switch valve on the pipe connected with the outside sewage pipe.

5. The automatically cleaned filter with cotton core according to claim 4, wherein the outer case is connected at its one outlet with a secondary filter in which the active carbon is provided, said secondary active filter is connected with said pump.

6. The automatically cleaned filter with cotton core according to claim 4, wherein the agitator Is of fan-blade type.

7. The automatically cleaned filter with cotton core according to claim 1, wherein the cleaning apparatus is an agitator installed inside the outer case which is connected with the motor at the front side of the outer case, the outer case has one water inlet and one outlet, one pump is installed at the inlet, one secondary screening unit or sewage pipe as well as one switch valve are provided at the outlet.

8. The automatically cleaned filter with cotton core according to claim 1, wherein the cleaning apparatus is an agitator installed inside the outer case which is connected with the motor at bottom of the outer case, the outer case has one water inlet and one outlet at its bottom, one water outlet is provided at its top, one pump is provided at its water inlet and one switch valve is provided at water outlet of its bottom, as well as one secondary filter is provided at the outlet of the top, said secondary filter has active carbon inside.

9. The automatically cleaned filter with cotton core according to claim 1, wherein the cleaning apparatus is an agitator installed inside the outer case which is connected with the motor at the upper side of the outer case, the outer case has one water inlet and one outlet at its top, one pump is provided at its water inlet, one splitter is provided at said water outlet, as well as one secondary filter is provided at the bottom, said secondary filter has active carbon inside.

10. The automatically cleaned filter wit cotton core according to claim 8, wherein there is a filter screen between active carbon and cotton core.

11. The automatically cleaned filter with cotton core according to claim 1, wherein a removable lid is provided on said cylinder or the cylinder is closed.

12. The automatically cleaned filter with cotton core according to claim 1, wherein the cotton core can be made of one of the cotton, cloth, mesh, filter foam rubber, or filter screen or filter line that is used for the air conditioner.

13. The automatically cleaned filter with cotton core according to claim 1, wherein said cotton core can be made in bag shape, in which the active carbon or the cotton core into which the active carbon is added is provided.

14. The automatically cleaned filter with cotton core according to claim 9, wherein there is a filter screen between active carbon and cotton core.

15. The automatically cleaned filter with cotton core according to claim 2, wherein a removable lid is provided on said cylinder or the cylinder is closed.

16. The automatically cleaned filter with cotton core according to claim 12, wherein said cotton core can be made in bag shape, in which the active carbon or the cotton core into which the active carbon is added is provided.
